(19) United States
(12) Patent Application Publication
(10) Pub. No.: US 2012/0257614 A1
(43) Pub. Date: Oct. 11, 2012

(54) METHOD AND APPARATUS FOR DERIVING FINE TIMING TO ASSIST POSITION ACQUISITION IN A COMMUNICATION NETWORK

(76) Inventors: Tom Chin, San Diego, CA (US); Guangming Shi, San Diego, CA (US); Kuo-Chun Lee, San Diego, CA (US)

(21) Appl. No.: 13/271,951

(22) Filed: Oct. 12, 2011

Related U.S. Application Data
(60) Provisional application No. 61/472,531, filed on Apr. 6, 2011.

(51) Int. Cl. H04B 7/216

(52) U.S. Cl. 370/342

(57) ABSTRACT

In wireless communication systems network timing may assist position location operations. A user equipment may obtain a rough network time from a server to tag when a downlink frame is received. That time may be based on a network frame boundary, particularly for synchronous networks. An estimate of the one way delay, which may be half of a timing advance value, may be added to arrive at a fine timing estimate. The fine timing estimate may assist with position location when there is a delay by a position location receiver in determining the user equipment's location.

### CROSS REFERENCE TO RELATED APPLICATION

This application claims the benefit of U.S. provisional patent application no. 61/472,531 filed Apr. 6, 2011, in the names of CHIN, et al., the disclosure of which is expressly incorporated herein by reference in its entirety.

### BACKGROUND

1. Field

Aspects of the present disclosure relate generally to wireless communication systems, and more particularly, to techniques deriving fine timing to assist position location acquisition in a TD-SCDMA network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a timing diagram conceptually illustrating uplink and downlink transmissions in a TD-SCDMA system.

FIG. 5 is a timing diagram conceptually illustrating uplink and downlink transmissions in a TD-SCDMA system according to one aspect of the present disclosure.

FIG. 6 is a functional block diagram illustrating example blocks, which may be executed by a fine timing module, executed to implement one aspect of the present disclosure.

FIG. 7 is a block diagram illustrating components for communicating in a wireless network according to one aspect of the disclosure.

### SUMMARY

Offered is a method for wireless communication. The method includes tagging a downlink frame with a downlink frame receive time using a coarse time from a received Time Division-Synchronous Code Division Multiple Access (TD-SCDMA) time protocol. The method also includes deriving a downlink frame transmission time for the tagged downlink frame, based on the downlink frame receive time. The method further includes estimating a fine time based on the downlink frame transmission time and a transmission delay between a base station and a user equipment.

Offered is a user equipment configured for wireless communication. The user equipment includes means for tagging a downlink frame with a downlink frame receive time using a coarse time from a received Time Division-Synchronous Code Division Multiple Access (TD-SCDMA) time protocol. The user equipment also includes means for deriving a downlink frame transmission time for the tagged downlink frame, based on the downlink frame receive time. The user equipment further includes means for estimating a fine time based on the downlink frame transmission time and a transmission delay between a base station and a user equipment.

Offered is a computer program product including a non-transitory computer-readable medium having program code recorded thereon. The program code includes program code to tag a downlink frame with a downlink frame receive time using a coarse time from a received Time Division-Synchronous Code Division Multiple Access (TD-SCDMA) time protocol. The program code also includes program code to derive a downlink frame transmission time for the tagged downlink frame, based on the downlink frame receive time. The program code further includes program code to estimate a fine time based on the downlink frame transmission time and a transmission delay between a base station and a user equipment.

Offered is a user equipment configured for wireless communication. The user equipment includes a processor(s) and a memory coupled to the processor(s). The processor(s) is configured to tag a downlink frame with a downlink frame receive time using a coarse time from a received Time Division-Synchronous Code Division Multiple Access (TD-SCDMA) time protocol. The processor(s) is also configured to derive a downlink frame transmission time for the tagged downlink frame, based on the downlink frame receive time. The processor(s) is also configured to estimate a fine time based on the downlink frame transmission time and a transmission delay between a base station and a user equipment.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

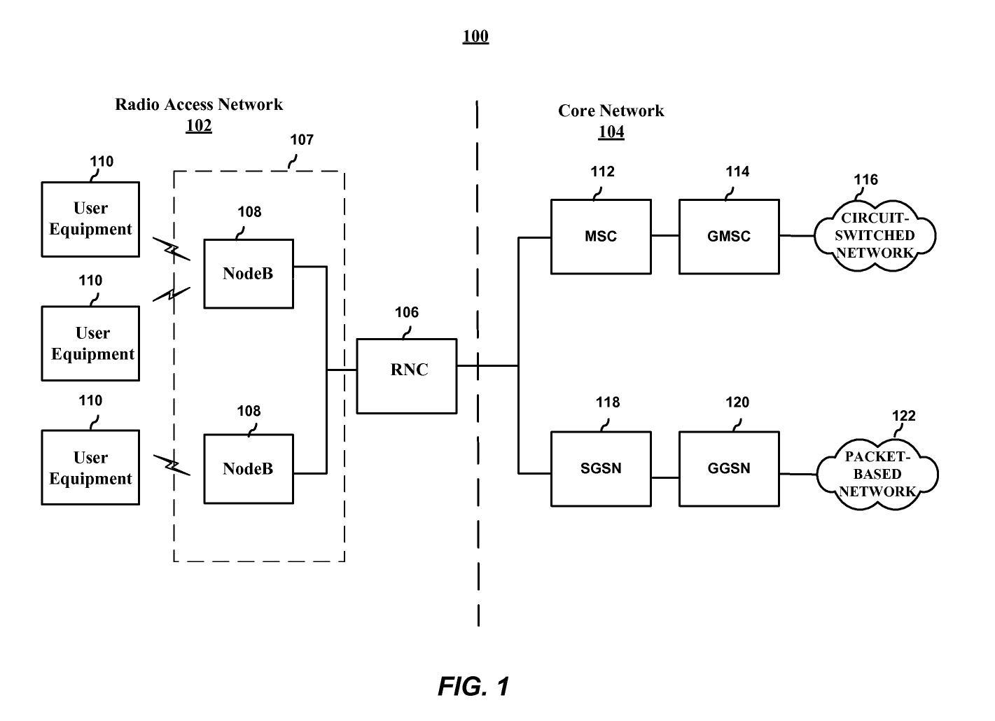

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

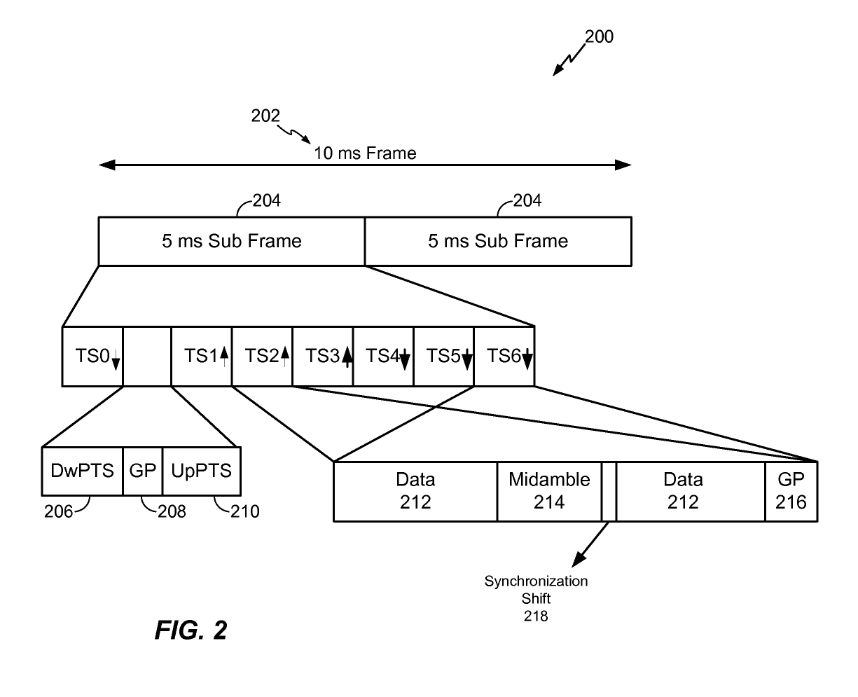

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

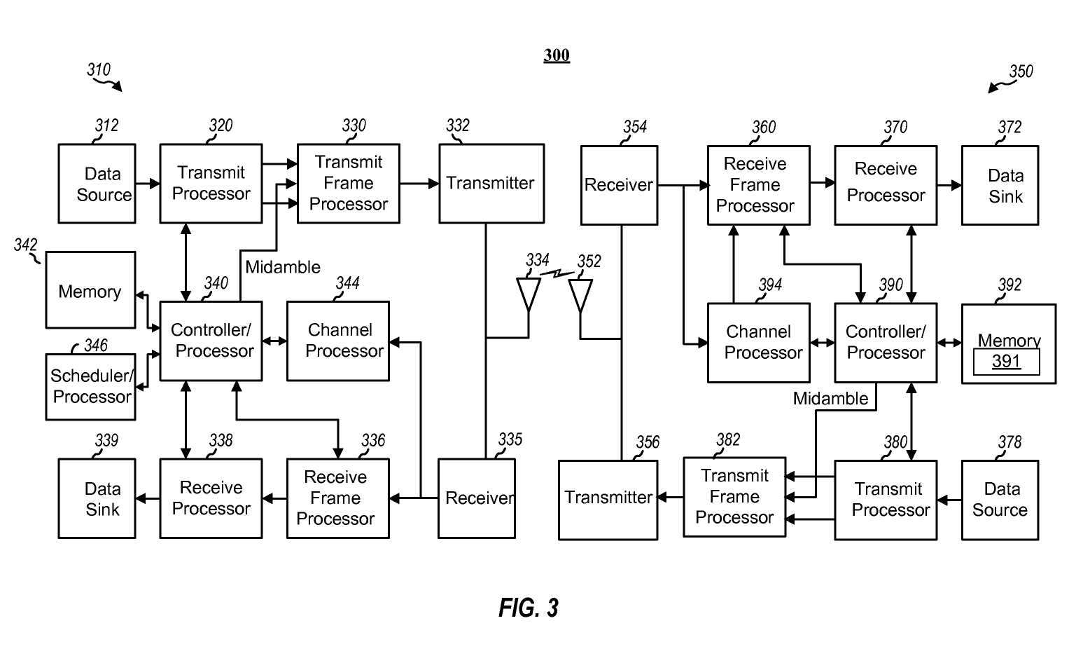

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a fine timing module 391 which, when executed by the controller/processor 390, configures the UE 350 for fine timing module. A scheduler/processor 346 at the node B 310 may be used to allocate resources to the UEs and schedule downlink and/or uplink transmissions for the UEs.

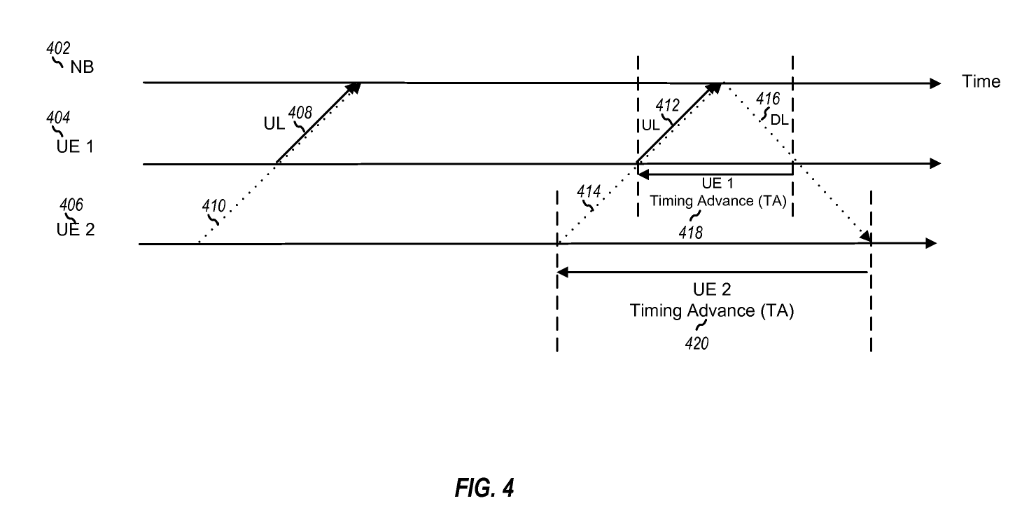

In TD-SCDMA, uplink transmission is synchronized at the node B. For example as shown in FIG. 4, the uplink transmissions of UE 1 404 and UE 2 406 are controlled to arrive at the node B 402 at the same time. As illustrated, uplink transmission 408 from UE 1 404 and uplink transmission 410 from UE 2 406 arrive at the node B 402 at the same time. Control of uplink transmission to coordinate arrival time at the node B is performed by the UE to properly advance its uplink transmission of a 10-ms long frame relative to the received downlink 10-ms frame time. This advance is called timing advance (TA). As shown in FIG. 4, the UE 1 timing advance 418 is twice the amount of the propagation delay between the UE and node B, that is the amount of time for an uplink signal 412 from UE 1 404 to reach the node B 402 plus the time for a downlink message from the node B 402 to reach UE 1 404. Similarly, the UE 2 timing advance 420 is the amount of time for an uplink signal 414 from UE 2 406 to reach the node B 402 plus the time for a downlink message 416 from the node B 402 to reach UE 2 406.

The TD-SCDMA protocol provides some methods to properly advance the uplink transmission timing. First, in the random access procedure, the UE sends synchronization uplink (SYNC_UL) codes on the Uplink Pilot Time Slot (UpPTS), and the node B measures and sends to the UE the timing information on the Fast Physical Access Channel (FPACH). Table 1 shows the Fast Physical Access Channel message format where the received starting position of the UpPCH (UpPCHPOS) parameter may be used to initially determine the timing advance value at the UE.

TABLE 1

| Field | Length | Description |
|---|---|---|
| Signature Reference Number | 3 (most | Indicates |
| | significant | SYNC_UL code |
| | bits) | |
| Relative Sub-Frame Number | 2 | Sub-Frame number |
| | | preceding the |
| | | acknowledgment |
| | | (ACK) |
| Received starting position of the | 11 | Used for timing |
| UpPCH (UpPCHPOS) | | correction |
| Transmit Power Level Command for | 7 | Used for power |
| random access channel (RACH) | | level in physical |
| message | | random access |
| | | channel (PRACH) |
| Reserved bits | 9 (least | N/A |
| | significant | |
| | bits) | |

When the downlink dedicated physical channel (DL DPCH) and uplink dedicated physical channel (UL DPCH) are set up, the node B can receive the midamble of the received uplink dedicated physical channel. The node B can then measure and send the synchronization shift (SS) command in the downlink dedicated physical channel to the UE to adjust the timing advance value. As a result, the UE may use the Fast Physical Access Channel message and synchronization shift commands to adjust the uplink transmission timing relative to the received downlink time. That is, the timing advance is decided by the Fast Physical Access Channel acknowledgement (ACK) and accumulated synchronization shift commands received by the UE.

Typically a mobile station (UE) has a position location (e.g., global positioning system (GPS)) receiver to provide location based information and services. One drawback with a position location receiver is the time to acquire the time and a fix on the UE's position. Assistance may be desired to speed up such position/time acquisition. For example, the network may provide the satellite orbital information to assist the UE to acquire the position location signal. Also, if the UE can have improved precision in its timing, the UE can narrow the search window of the satellite signal to speed up satellite signal acquisition and signal measurement.

Offered is a method of improving the precision of UE timing to improve position/time acquisition through the use of timing information from TD-SCDMA signals.

One feature in a TD-SCDMA network is that all node Bs are synchronous with their 10-ms frames. For TD-SCDMA, the 10-ms frame is in sync with the second pulse of the GPS time. Proposed is a method to use the TD-SCDMA signal to derive fine timing to assist the GPS operation. Although GPS is described, the present disclosure can be applied to other position location systems.

First, a UE may use the network time protocol (NTP) to receive a rough (also called coarse) time from the server in the network. This time then tags when a specific downlink frame is received, denoted by the reference t (in units of 10 milliseconds, corresponding to the TD-SCDMA frame length). Note that t is not necessarily an integer and may have some fractional portion. Next, the UE derives when the downlink 10-ms frame is transmitted at a node B (called T_NB) through Equation 1:

T_{—}NB=FLOOR{t+0.5} (in units of 10 milliseconds) (Equation 1)

FLOOR is a mathematical function indicating the largest integer not greater than the number. Thus FLOOR(x), expressed as └x┘, means the largest integer not greater than x. For example, FLOOR(3.5)=3, and FLOOR(2.324)=2.

Note that for Equation 1 the result of T_NB should be an integer because the NB transmits the 10-ms frame at multiples of 10 milliseconds. Equation 1 may reduce or eliminate the error of the coarse network time protocol time described above which is around the millisecond order. Reducing/eliminating the error is achieved by the floor function plus 0.5, FLOOR {*+0.5} which can take the closest 10 milliseconds time. For example, if t=100.1 with an error of +/−0.1, T_NB=FLOOR{100.1+0.5}=100 (all numbers are in unit of 10 milliseconds).

To estimate correct timing at the UE when it receives the downlink 10-ms frame, the one way delay between the node B and the UE may be added. This one way delay is actually half of the current timing advance value (TA). Therefore the downlink 10-ms time (T) received at the UE is described in Equation 2:

$$T = T\_NB + \frac{T A}{2} \qquad ( Equation 2 )$$

The timing adjustment (TA) can be on the order of fractional micro-second accuracy which allows for an estimate of more precise (i.e., fine) timing for the value of T. Although TA/2 is used in Equation 2, other values and functions may be used to estimate the downlink time.

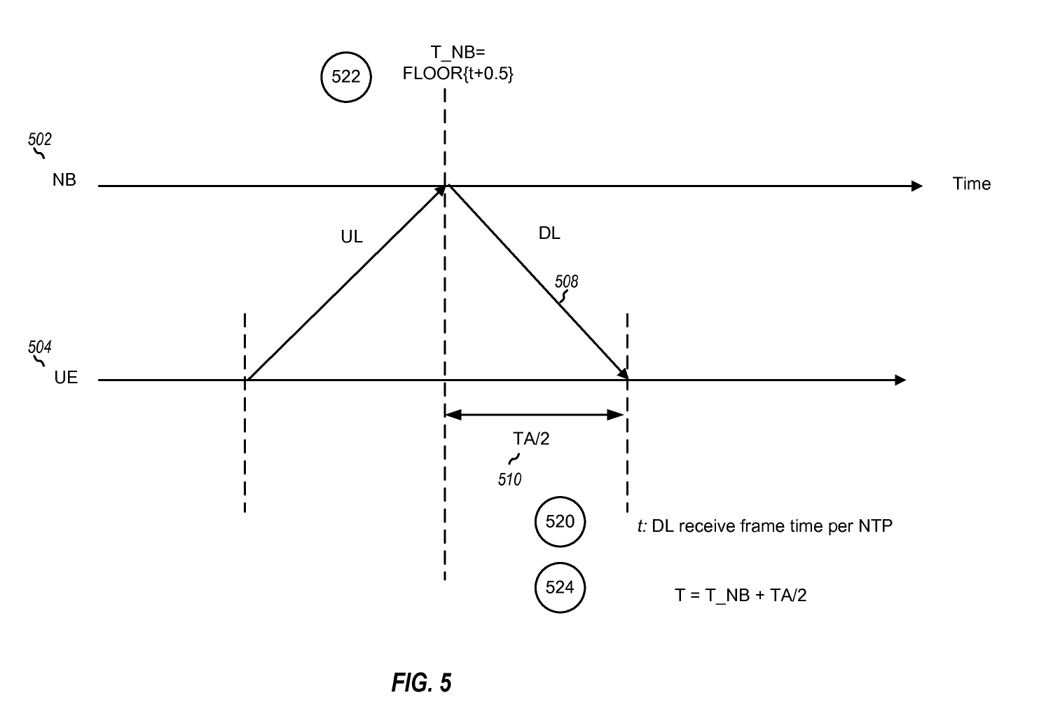

FIG. 5 illustrates the above procedure to calculate a fine timing value of T. The UE 504 tags a downlink frame 508 with a time reference t, as shown at 520. Next the UE derives a time for frame transmission from the node B 502, T_NB, using Equation 1 as shown at 522. Then, the UE calculates a fine time (T) of receipt of the downlink frame 508 using TA/2 as shown at 524.

Once the above time is adjusted at the UE, the time can start to run continuously and the fine timing may be available to assist with position location. The fine timing can be as accurate as fractional micro-seconds with respective to the GPS time.

In one configuration, the apparatus, for example the UE 350, for wireless communication includes tagging means, deriving means, and estimating means. In one aspect, the aforementioned means may be the antennas 352, the receiver 354, the channel processor 394, the receive frame processor 360, the receive processor 370, the transmitter 356, the transmit frame processor 382, the transmit processor 380, the controller/processor 390, the memory 392, and/or the fine timing module 391 configured to perform the functions recited by the aforementioned means. In another aspect, the aforementioned means may be a module or any apparatus configured to perform the functions recited by the aforementioned means.

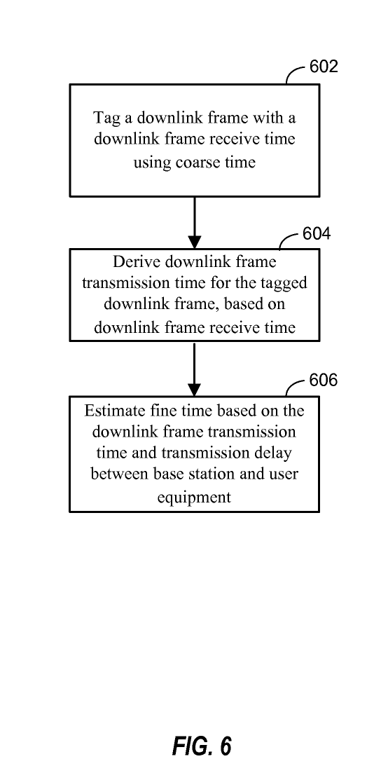

The fine timing module 391 can be hardware, software, or any combination of the two. High level functionality of the fine timing module 391 is now described with respect to FIG. 6. As shown in block 602 of FIG. 6, a UE, through the fine timing module 391, may use a coarse time from a received TD-SCDMA time protocol for tagging a downlink frame with a downlink frame receive time. The UE may also derive a downlink frame transmission time for the tagged downlink frame, based on the downlink frame receive time, as shown in block 604. The UE may also estimate a fine time based on the downlink frame transmission time and a transmission delay between a base station and a user equipment, as shown in block 606.

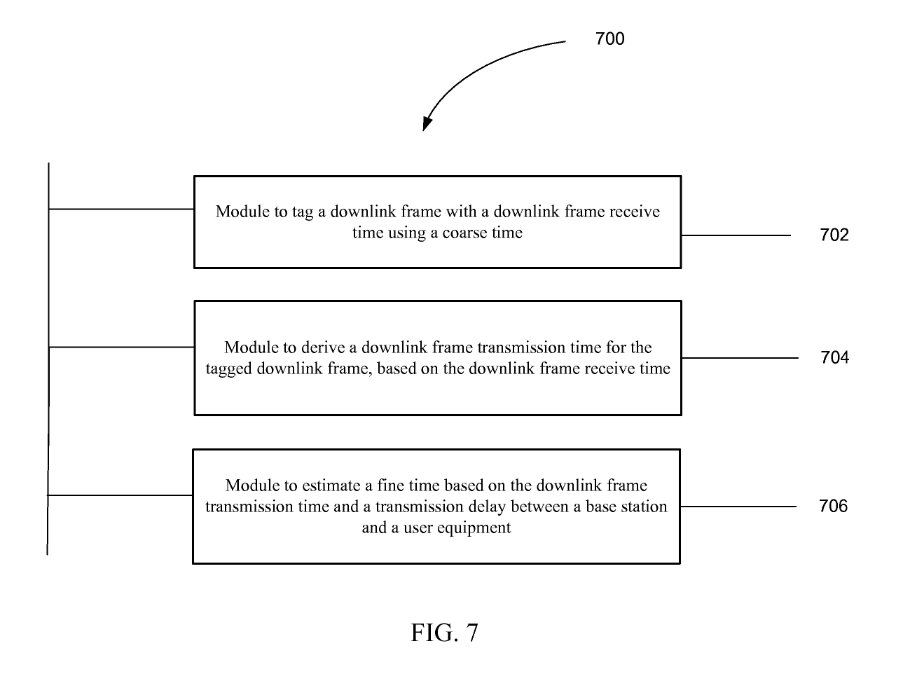

FIG. 7 shows a design of an apparatus 700 for a UE. The apparatus 700 includes a module 702 to tag a downlink frame with a downlink frame receive time using a coarse time from a TD-SCDMA time protocol. The apparatus also includes a module 704 to derive a downlink frame transmission time for the tagged downlink frame, based on the downlink frame receive time. The apparatus also includes a module 706 to estimate a fine time based on the downlink frame transmission time and a transmission delay between a base station and a user equipment. The modules in FIG. 7 may be processors, electronics devices, hardware devices, electronics components, logical circuits, memories, software codes, firmware codes, etc., or any combination thereof.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
tagging a downlink frame with a downlink frame receive time based on a coarse time from a received Time Division-Synchronous Code Division Multiple Access (TD-SCDMA) time protocol;
deriving a downlink frame transmission time for the tagged downlink frame, based on the downlink frame receive time; and
estimating a fine time based on the downlink frame transmission time and a transmission delay between a base station and a user equipment.

2. The method of claim 1 further comprising deriving a position location using the fine time.

3. The method of claim 1 in which deriving the downlink frame transmission time is based on a floor function of the downlink frame receive time.

4. The method of claim 1, in which the transmission delay comprises half of a current timing advance value.

5. The method of claim 1, in which the coarse time is determined relative to a frame boundary.

6. A user equipment (UE) configured for wireless communication, the UE comprising:
means for tagging a downlink frame with a downlink frame receive time using a coarse time from a received Time Division-Synchronous Code Division Multiple Access (TD-SCDMA) time protocol;
means for deriving a downlink frame transmission time for the tagged downlink frame, based on the downlink frame receive time; and
means for estimating a fine time based on the downlink frame transmission time and a transmission delay between a base station and a user equipment.

7. The user equipment of claim 6 further comprising means for deriving a position location using the fine time.

8. The user equipment of claim 6 in which deriving the downlink frame transmission time is based on a floor function of the downlink frame receive time.

9. The user equipment of claim 6, in which the transmission delay comprises half of a current timing advance value.

10. The user equipment of claim 6, in which the coarse time is determined relative to a frame boundary.

11. A computer program product, comprising:
a non-transitory computer-readable medium having program code recorded thereon, the program code comprising:
program code to tag a downlink frame with a downlink frame receive time using a coarse time from a received Time Division-Synchronous Code Division Multiple Access (TD-SCDMA) time protocol for;
program code to derive a downlink frame transmission time for the tagged downlink frame, based on the downlink frame receive time; and
program code to estimate a fine time based on the downlink frame transmission time and a transmission delay between a base station and a user equipment.

12. The computer program product of claim 11 in which the program code further comprises program code to derive a position location using the fine time.

13. The computer program product of claim 11 in which deriving the downlink frame transmission time is based on a floor function of the downlink frame receive time.

14. The computer program product of claim 11, in which the transmission delay comprises half of a current timing advance value.

15. The computer program product of claim 11, in which the coarse time is determined relative to a frame boundary.

16. A user equipment (UE) configured for wireless communication, comprising:
at least one processor; and
a memory coupled to the at least one processor,
the at least one processor being configured:
to tag a downlink frame with a downlink frame receive time using use a coarse time from a received Time Division-Synchronous Code Division Multiple Access (TD-SCDMA) time protocol;
to derive a downlink frame transmission time for the tagged downlink frame, based on the downlink frame receive time; and
to estimate a fine time based on the downlink frame transmission time and a transmission delay between a base station and a user equipment.

17. The user equipment of claim 16 in which the at least one processor is further configured to derive a position location using the fine time.

18. The user equipment of claim 16 in which the at least one processor is further configured to derive the downlink frame transmission time is based on a floor function of the downlink frame receive time.

19. The user equipment of claim 16, in which the transmission delay comprises half of a current timing advance value.

20. The user equipment of claim 16, in which the coarse time is determined relative to a frame boundary.
